(19) United States
(12) Patent Application Publication
(10) Pub. No.: US 2023/0235846 A1
(43) Pub. Date: Jul. 27, 2023

(54) METHOD AND SYSTEM FOR A HYDROPHILIC-COATED PIPE LINER

(71) Applicant: VORTEX TECHNOLOGY GROUP, LLC, Houston, TX (US)

(72) Inventor: Stephen V. GEARHART, Fort Myers, FL (US)

(73) Assignee: VORTEX TECHNOLOGY GROUP, LLC, Houston, TX (US)

(21) Appl. No.: 18/160,133

(22) Filed: Jan. 26, 2023

Related U.S. Application Data
(60) Provisional application No. 63/303,319, filed on Jan. 26, 2022.

(51) Int. Cl. F16L 55/165

(52) U.S. Cl. CPC F16L 55/1656

(57) ABSTRACT

A fabric tube liner for underground conduits, passageways, and pipelines, wherein such liner shrinks minimally upon curing and wherein any gaps between the liner and the host pipe are sealed with a hydrophilic coating. The liner may be used in conjunction with the known processes of lining underground conduits, passageways, and pipelines by either the eversion process or a pull-in liner using a winch and cable. The liner may be impregnated with a resin or resin may be applied after the liner has been installed in the underground host pipe. Upon contact with liquid permeating from the environment or leaking from the interior of the host pipe, the outer coating of the liner will expand to create a seal at the leak and prevent further leakage

### CROSS-REFERENCE TO RELATED APPLICATIONS

The present application claims priority to provisional patent application 63/303,319 which was filed on Jan. 26, 2022, and is hereby expressly incorporated by reference in its entirety.

### BACKGROUND

This invention generally relates to the lining of conduits, passageways, and pipelines, particularly those underground, such as sanitary sewer pipes, storm sewer pipes, water lines and gas lines that are employed for conducting fluids. Such underground pipes deteriorate over time and experience fluid loss, or collapse due to structural damage or inability to support surrounding conditions. Infiltration of outside elements into the pipes or other conduits is a major concern for aged pipes and conduits. It is well known in the art to line an existing underground pipe or passageway by introducing a flexible tubular liner into the pipe at one end. These tubular liners create a barrier in deteriorating pipes to reduce leakage and/or structural collapse. Leakage may include fluid loss out of a pipe and into the surrounding environment through holes in the pipe. Alternatively, leakage may be inward from the environment into the interior or conducting portion of the pipe.

Typically, such liners include felt, fabric, fiber, glass fiber, or carbon fiber or a composite of a combination of these that are impregnated with a curable resin. In one known method to install the liner, the liner may be placed into one end of the pipe. The liner is then pulled through the one end and then progresses through the pipe that is to be rehabilitated as it is pulled in by a winch. Resin is either impregnated into the liner prior to installation or applied to the liner in the pipe. When the liner is in place, then a calibration hose or tube manufactured for such purpose is everted inside of the pulled in place liner, the calibration hose or tube manufactured for this purpose is attached to connections at an A and B station in order to apply radial pressure against the pulled in place liner and to expand the liner against the host pipe allowing enough stretch for the liner to dimple at service connections or laterals. A typically is for the introduction of steam or hot water and pressure. B is typically to control the flow of curing medium and to monitor pressures within the liner/calibration hose or tube manufactured for this purpose. Radial pressure may be provided by an inflatable bladder or tube everted within the liner to cause it to cure against the inner wall of the host pipe. A separate curing process using heat or another curing method may also be applied to the liner to cure the resin.

The resin is cured to form a hard, rigid, impermeable lining within the existing pipe. The new liner seals any cracks or holes in the host pipe section to prevent further leakage into or out of the pipe or structural collapse. The cured liner also serves to strengthen the existing pipeline wall to provide added structural support for the surrounding environment.

However, in the curing process, typical utilized resins are polyester or vinyl ester resins, which incur shrinkage, usually between seven to ten percent of the wetout liner size prior to cure of the resin. When the liner shrinks, gaps are created between the liner and the host pipe. At these gaps, the liner is unsupported by the host pipe, causing the liner to deteriorate more quickly at the locations of such gaps. The deteriorated host pipe is also not supported internally at these gaps, causing greater chance of further deterioration at the locations of such gaps. The additional movement of groundwater between the liner and the host pipe allows for movement of bedding soils surrounding the host pipe thereby providing for an unsupported host pipe causing it to be unstable and more susceptible to collapse.

In addition, shrinkage after the resin cures causes shrinkage around each fiber of the liner, creating porosity and greater chance of pinholes and other leakage through the walls of the liner.

It is therefore an object of the present invention to provide a liner for underground conduits, passageways, and pipelines that does not shrink or create gaps between the liner and the host pipe.

It is another object of the present invention to provide a liner that is coated with a hydrophilic material, which expands upon contact with a liquid to create a watertight seal in any gaps between the liner and the host pipe.

### SUMMARY OF THE INVENTION

The present invention includes a fabric tube wall (a liner) for underground conduits, passageways, and pipelines, wherein such liner shrinks minimally upon curing and wherein any gaps between the liner and the host pipe are sealed with a hydrophilic coating. The liner may be used in conjunction with the known processes of lining underground conduits, passageways, and pipelines by either the eversion process or a pull-in liner using a winch and cable. The liner may be impregnated with a resin or resin may be applied after the liner has been installed in the underground host pipe.

The liner is also coated with an outer coating that includes a hydrophilic material and/or a compressible material which is between the liner and the interior of the host pipe. Upon contact with liquid permeating from the environment or leaking from the interior of the host pipe, the outer coating will expand to create a seal at the leak and prevent further leakage. The compressible material can be Neoprene or any compressible rubber. Some Neoprenes have the advantage of also being hydrophilic. In lieu of the liner outer coating being hydrophilic, a slurry of hydrophilic material can be prepared and introduced to the host pipe while the liner is being winched into place.

### BRIEF DESCRIPTION OF THE DRAWINGS

FIG. 1 is a cross-section of the host pipe with the liner installed;

FIG. 2 is a drawing of a host pipe with the liner and a process for installation of the liner.

### DETAILED DESCRIPTION

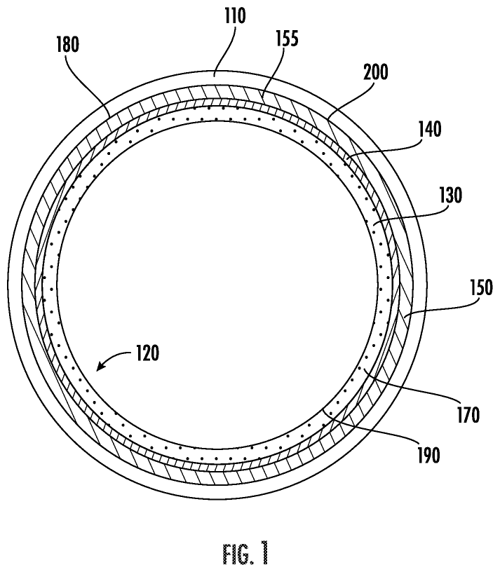

Now referring to the drawings, FIG. 1 shows a host pipe 110 and liner 120. The liner 120 preferably comprises a curable layer 130, a liner coating 140, and an outer coating 150. A calibration hose 160 can be utilized for installation and can become a part of the liner 120 or the calibration hose 160 can be removed after installation. The liner 120 material may include fabric, fiberglass, felt, carbon fiber, recyclable plastics or some combination of those materials. Furthermore, the liner 120 may include other materials that can act as a carrier of a suitable resin. The liner 120 includes a resin 170 indicated by the dots in the curable layer 130 that may have additives that are either synthetic or natural that eliminates any shrinkage of the cured product which may be impregnated in the curable layer 130 or may be applied to the curable layer 130 after installation in the host pipe 110.

In one embodiment, the outer coating 150 is a hydrophilic material 155 that covers the liner coating 140, or the liner coating 140 may be a composite of a sealing material along with a hydrophilic material 155 that may be natural or synthetic. The outer coating 150 interfaces with an interior surface 180 of the host pipe 110. The hydrophilic material 155 of the outer coating 150 can be a material including at least one of a polymer and a clay or a hydrophilic rubber or a compressible synthetic foam material. Another embodiment has an outer coating 150 that is a compressible rubber that may or may not be hydrophilic. Utilization of Neoprene allows a compressible rubber that can also be hydrophilic.

The liner 120 is preferably installed by being pulled through an underground host pipe 110. In the eversion method to install the liner 120, the liner 120 may be placed into one end of the host pipe 110. The liner 120 then progresses via an eversion process throughout the host pipe 110 and makes contact with the interior surface 180. The liner 120 can also be installed by a winch which pulls the liner 120 in place.

Once the liner 120 with the resin 170 is installed, and a calibration hose or tube manufactured for this purpose is everted within the liner 120 a radial force r is applied to the interior 190 of the liner 120 to press the exterior surface 200 of the liner 120 against the interior surface 180 of the host pipe 110. The resin 170 may be cured by any known method resulting in a hardened, impermeable liner 120 installed in the host pipe 110. Current curing methods employ the application of heat through microwave, steam, hot water, infrared radiation or UV radiation to effectuate the cure. Certain additions of filler materials may be added to the resin 170 in order to provide for minimal, if any, shrinkage of the liner 120 during the curing process. Suitable fillers include milled graphite, alumina trihydrate, milled talc, powdered glass and/or fumed silicates. Upon curing, the resin 170 which may or may not contain additives either natural or synthetic has minimal shrinkage or no shrinkage. As the liner 120 is subjected to exposure to water, the embodiments having the hydrophilic materials 155 in the outer coating 150 will expand and form an impermeable seal against any water migration for the entire length of the host pipe 110.

Any leakage from (i) outside the host pipe 110 or (ii) the interior 190 of the liner 120, and into any gap between the host pipe 110 and the liner 120, the hydrophilic materials 155 of the outer coating 150 shall absorb the leaked liquid and expand to create a seal at that point. Additionally, the introduced slurry will provide either additional sealing or primary sealing of any resulting gap or void that would be present after the curing process.

The outer coating 150 can be applied through a number of methods. In one method, the hydrophilic materials 155 are part of an expandable polymeric coating which forms the outer coating 150 of the liner 120. A second method has outer coating 150 having a compressible coating that will provide a gasket between the host pipe 110 and the liner coating 140. A third method uses an expandable hydrophilic slurry during the insertion of a liner that will in turn coat the liner 120 as it is being inflated and cured. The slurry forms the outer coating 150 of the liner 120. Preferably the slurry is a clay and/or bentonite slurry or of a synthetic hydrophilic substance. Utilizing a slurry assists in eliminating any void or annulus after the curing process.

For this specification, it is to be understood that the outer coating 150 can be one of several coatings or layers of the liner 120. While the preferred embodiment has the hydrophilic materials 155 in the furthest layer or coating of the liner 120 as measured from the center of the pipe, other embodiments wherein the outer coating 150 actually have additional coatings or layers on the outer coating 150 are contemplated. In these type of embodiments, the additional coatings or layers may protect the outer coating 150. As the pipe and/or these additional coatings or layers fail or deteriorate, water will eventually make contact with the outer coating 150 containing the hydrophilic materials 155. Accordingly, the hydrophilic materials will swell and create a seal and will eliminate any annulus that may exist.

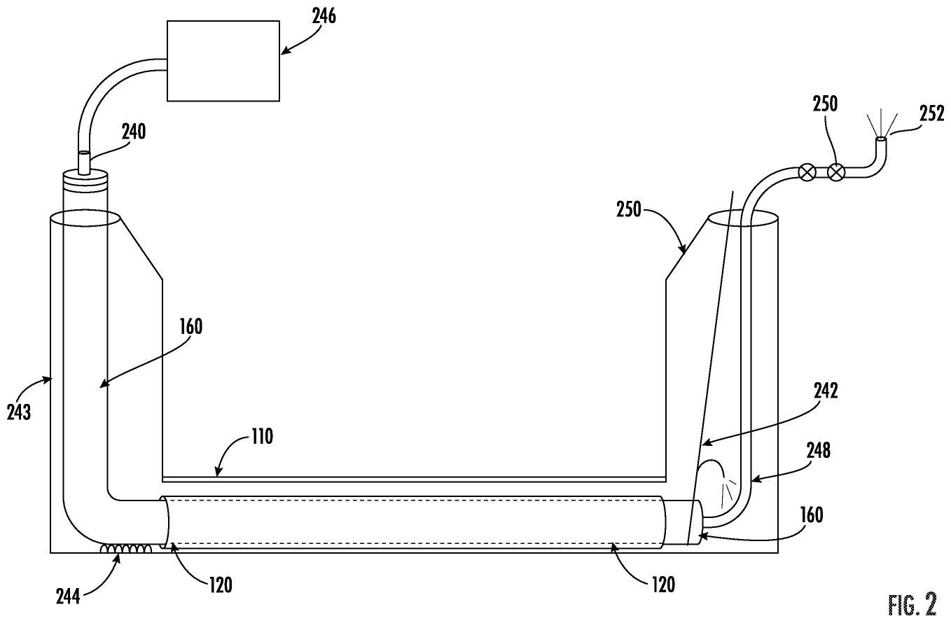

Now referring to FIG. 2, a host pipe 110 is shown between two manholes 242 and 243. The liner 120 can be placed in the host pipe 110 by utilizing several methods, including the one detailed in FIG. 2. The liner 120 with outer coating 150 is pulled into the host pipe 110. The calibration hose 160 is inverted on the inside of the liner 120. A connection 240 allows steam and air from a boiler/air compressor 246 to enter the host pipe 110. The steam and air cures the liner 120 through the calibration hose 160. A condensate removal rod 242 is utilized to remove moisture from the system. A slurry 244 that can be polyethylene oxide and/or bentonite lubricates the host pipe 110 to assist in the pulling of the liner 120. Additionally, a hose 248 can be utilized in connection with a pressure monitor 250 and an exhaust 252 to control the pressure in the host pipe 110 during installation of the liner 120.

The calibration hose 160 could be omitted in instances wherein the liner 120 is manufactured with an inner coating of polyurethane along with an outer coating 150 of a hydrophilic or compressible rubber composite. The liner 120 would be wet and pulled into place. Similar connections shown in FIG. 2 would be utilized to pressure and cure the liner 120 in the host pipe 110.

Having thus described the invention in connection with the several embodiments thereof, it will be evident to those skilled in the art that various revisions can be made to the several embodiments described herein without departing from the spirit and scope of the invention. It is my intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A liner for an interior of a pipe, comprising:
an outer coating;
a curable layer;
the outer coating has hydrophilic materials;
wherein the hydrophilic materials are configured to expand when exposed to a liquid.

2. The liner of claim 1, wherein:
the hydrophilic materials include a polymer.

3. The liner of claim 1, wherein:
the hydrophilic materials include a clay.

4. The liner of claim 1, wherein:
the hydrophilic materials include a compressible foam.

5. The liner of claim 1, wherein:
the hydrophilic materials include a compressible rubber.

6. The liner of claim 1, wherein:
the curable layer has a resin.

7. The liner of claim 6, wherein:
the resin is subjected to a curing method;
wherein the curing layer is hardened.

8. The liner of claim 7, wherein:
the hydrophilic materials are part of a hydrophilic slurry that forms the outer coating.

9. The liner of claim 8, wherein:
the hydrophilic slurry is a bentonite slurry.

10. The liner of claim 8, wherein:
the hydrophilic slurry is a clay slurry.

11. A liner for an interior of a pipe, comprising:
an outer coating;
the outer coating having a hydrophilic material;
the hydrophilic materials are part of a hydrophilic slurry that forms the outer coating;
wherein the hydrophilic materials are configured to expand when exposed to a liquid.

12. The liner of claim 11, further comprising:
a curable layer.

13. The liner of claim 11, wherein:
the hydrophilic materials include a clay.

14. The liner of claim 11, wherein:
the hydrophilic materials include a compressible foam.

15. The liner of claim 11, wherein:
the hydrophilic materials include a compressible rubber.

16. The liner of claim 11, wherein:
the hydrophilic slurry is a bentonite slurry.

17. The liner of claim 11, wherein:
the hydrophilic slurry is a clay slurry.

18. A method for coating a pipe with a liner, comprising the steps of:
coating an outside of the liner in a slurry;
allowing the slurry to adhere to the outside of the liner;
the slurry includes hydrophilic materials;
wherein the wherein the hydrophilic materials are configured to expand when exposed to a liquid.
